(19) United States
(12) Patent Application Publication
(10) Pub. No.: US 2016/0078550 A1
(43) Pub. Date: Mar. 17, 2016

(54) METHOD OF GENERATING MARKET INTELLIGENCE

(71) Applicant: GlobalTrack Africa Limited, Port Louis (MU)

(72) Inventor: Petrus W. A. Smits, Sandton (ZA)

(21) Appl. No.: 14/851,152

(22) Filed: Sep. 11, 2015

(30) Foreign Application Priority Data
Sep. 12, 2014 (ZA) 2014/01856

(51) Int. Cl. G06Q 40/08; H04L 29/08; H04W 4/02

(52) U.S. Cl. CPC G06Q 40/08; H04W 4/02; H04L 67/306

(57) ABSTRACT

Disclosed is a method of generating market intelligence which includes the steps of providing an incentive to a social media service subscriber to allow access to his social media account data and geographical location data of a mobile communication device associated with the subscriber, accessing and analysing the subscriber's social media account data and geographical location data related to the subscriber to create a profile of the subscriber, and providing the profile to a third party offering products or services complimentary to the profile of the subscriber.

### FIELD OF THE INVENTION

This invention relates to the generation of data used for the marketing of products and services.

### BACKGROUND TO THE INVENTION

Marketing information systems analyse and assess marketing information gathered from various sources. Marketing information is essential for decisions relating to marketing products and services.

The successful marketing of products and services is influenced, at least in part, on marketing the products and services to a receptive audience. Quality market intelligence is required for this, which includes data on existing and potentially new customers, and data on consumer habits that allows such consumers to be targeted with intelligent marketing campaigns.

Consumers are constantly exposed to numerous sources of information, which has the effect of reducing the effectiveness of conventional marketing campaigns. Marketing campaigns that were successful just several years ago may now fail to deliver acceptable results, sometimes for no other reason than potential consumers filtering the information that they are exposed to and paying attention to only selected information. Consumers sometimes simply “tune out” when yet another marketing campaign reaches their eyes or ears.

An increased range of products and services to choose from is complicating matters for consumers and the companies marketing such products and services. This is colloquially referred to as consumer fatigue, and represents a trend where consumers have more choice than ever but simply become exhausted from having to consider all of these options. In such a case a consumer may end up simply buying a product or service that he already knows or not buying anything new at all.

This makes it very difficult for a company to successfully market its products or services to reach its intended target market, and even more so when the company is attempting to reach new markets. Simply increasing the marketing scope to more of the possible marketing channels, such as print media, television, radio, internet, mobile, software applications, emails, flyers, billboards and the like, is also not the answer since that increases the cost of a marketing campaign and further increases consumer fatigue.

The data available in social media networks have been identified as providing valuable insights into consumers and may lead to new consumers. The processing of the raw data that may be gathered from social media platforms such as Facebook, Twitter, LinkedIn, Google+ and the like, is not simple and merely having access to such data does not take a marketing company much further than being able to characterise people by age, sex and some personal preferences, such as books, movies and television programs the person likes.

There is a need to further increase the quality of market intelligence to provide more accurate data on existing customers and accurate data of potential new customers, allowing more accurate, relevant and personal marketing of products and services.

### OBJECT OF THE INVENTION

It is an object of the invention to provide a method of generating market intelligence for the marketing of products and services which at least partly overcomes the abovementioned problems.

### SUMMARY OF THE INVENTION

According to a first aspect of the invention there is provided a method of generating market intelligence including the steps of providing an incentive to a social media service subscriber to allow access to his social media account data and geographical location data of a mobile communication device associated with the subscriber, creating a profile of the subscriber by analysing data submitted to the social media service and geographical location data related to the subscriber, and providing the profile to a third party offering products or services complimentary to the profile of the subscriber.

There is further provided for the method to include the step of cross referencing data relating to the subscriber with a database relating to products or services of which the subscriber is a consumer, preferably being products or services offered by a third party, and incorporating data relating to the subscriber from such database into the subscriber's profile.

There is further provided for the third party to offer insurance products and services and for the data from such database that is incorporated into the subscriber's profile to include the claims history of the subscriber.

There is still further provided for the insurance products and services to comprise motor vehicle insurance and for the geographical location data to include data relating to the subscriber's driving behaviour, including data relating to:
the subscriber's adherence to speed limits in absolute terms;
the subscriber's acceleration and braking behaviour;
the subscriber's behaviour at negotiating corners;
the average distance the subscriber travels over a predetermined period of time;
the average distance the subscriber travels during low light conditions; and
the subscriber's adherence to corrected speed limits by reducing the absolute speed limit according to prevailing conditions including traffic, incidents or accidents on the road, and any special current weather such as rain, snow or hail.

There is further provided for the method to include accessing the subscriber's social media profile at least intermittently, and preferably continuously, and accessing the subscriber's geographical location data at least intermittently, and preferably continuously when the subscriber is travelling in a vehicle, and for the method to further include the step of determining that a subscriber is travelling in a vehicle by monitoring speed of movement and the location of the subscriber's mobile communication device, and when the travelling path of the subscriber's mobile communication device corresponds with road on a maps database and the speed of movement exceeds a predetermined minimum speed to determine that the subscriber is travelling in a vehicle.

There is further provided, in the instance where the insurance products and services comprise motor vehicle insurance, for the claims history data relating to the subscriber to include data relating to accidents in which the subscriber was involved, and for the data to further include data about the type of vehicle that is insured for the subscriber by the third party.

There is still further provided for the social media account data to include data relating to preferences of the subscriber for specific types of vehicles, including specifically vehicles within a predetermined group of vehicles classified by the third party as high risk vehicles, and preferably also data relating to the interests and characteristics of the subscriber.

There is further provided for the method to include categorising people associated with the subscriber into groups including friends, family and followers, and preferably for the method to include the step of incorporating data relating to subscriber into profiles of people associated with the subscriber, preferably to people categorised as friends of the subscriber.

There is further provided for the incorporation of data relating to the subscriber's profile into the profiles of people associated with the subscriber to include the step of determining whether the subscriber's profile includes a risk factor attributed to an interest or characteristic of the subscriber that is shared by a person associated to the subscriber, and to attribute such risk factor, at least partly, then also to the associated person's profile.

There is still further provided for the step of steps of providing an incentive to the subscriber to include transmitting to the subscriber's mobile communication device special offers relevant to the user's general geographical location, and preferably his current location as indicated by his mobile communication device, and further preferably to provide the subscriber with special offers associated with the interests and characteristics of the subscriber indicated on the subscriber's social media account data.

There is also provided for the special offer to be time limited, with an expiry date or time, and further for the special offer to be geographically limited and being set to expire once the subscriber travels to a location further than a predeterminable distance from the location of a merchant associated with the special offer.

These and other features of the invention are described in more detail below.

### DETAILED DESCRIPTION OF THE INVENTION

The harvesting of data from social media networks has been used in marketing campaigns, but the mere knowledge of details of subscribers to such services is not enough anymore to provide potential consumers of such data with a competitive edge. Such data has to be filtered in new and non-obvious ways to add value and thus intelligence to the data.

As alluded to before, marketing fatigue leaves potential consumers resistant and, to some extent, disinterested in marketing campaigns.

The method utilises the premise that a targeted approach to marketing that focusses on individual interests and characteristics is more successful in marketing, but still not enough. It also uses the premise that like-minded people flock together, and that being able to profile one person is a useful indication of the profile, at least as a starting point, of especially friends of that person. It uses such data as a lead to search for like-minded people, whose data may in turn also be used to search for more like-minded people. The more data that is gathered about a person and his or her circle of friends and acquaintances, the more accurate and hence valuable the data becomes.

The method also recognises that people are becoming more resistant to providing access to their private data, and hence provides an incentive to people to subscribe to the service that operates the method to overcome this resistance.

The method is particularly useful for services such as vehicle and health insurance, both of which are to a large extent influenced by personal behaviour of individually insured people.

In the case of vehicle insurance, individual driver behaviour is directly relevant to the risk profile of a driver. A young male driver with a history of traffic fines and accidents and who is driving a sporty car, is a far greater insurance risk than a middle aged male driver with only a few traffic fines and few, if any, accidents and who is driving a sedan. By extension, the friends of the young driver, especially those of similar age, can also reasonably be expected to be greater insurance risks than the middle-aged friends of the middle aged driver. The method of the invention provides a means to identify these people and to factor this assumption into the risk profile of each of those individuals, whether positive or negative.

As mentioned above health and life insurance is also affected by individual behaviour, and certain types of behaviours create higher risk for an insurer. For example, people partaking in so-called high-risk sports such as rock climbing or skydiving are obviously exposed to greater risk for serious injury or death. Friends of people with such interests may also be interested in such activities, and this may be used at least as a special note to an insurer to check on whether the friends of such a person do partake in such activities, to more accurately assess their individual insurance risk.

The method according to the invention accesses a subscriber to the system's social media profile and geographical data to essentially profile the subscriber by tracking his driving behaviour (in respect of his vehicle insurance risk) and by analysing data about the friends of the subscriber. In respect of the subscriber's profile for vehicle insurance this profiling seeks to identify risk factors about him, including any tendencies of the subscriber to:
accelerate fast;
decelerate hard (i.e. late);
exceed the stated speed limit and also relative to prevailing conditions, including traffic and any special current weather such as rain, snow or hail; or
corner at excessive speeds.

It may also seek to determine:
the average distance the subscriber travels over a predetermined period of time;
the average distance the subscriber travels during low light conditions; and
the subscriber's adherence to corrected speed limits by reducing the absolute speed limit according to prevailing conditions including traffic, incidents or accidents on the road, and any special current weather such as rain, snow or hail.

The data relating to a subscriber is used to profile him and may be provided to him with feedback on which of his actions specifically affects his risk profile. This is, to a subscriber interested in reducing his risk of accident, valuable and specific feedback. In addition to this personal feedback, the data is also used to profile people associated with the subscriber, especially his friends. Quite simply, with like-minded people flocking together the friends of a driver with a high-risk profile are more likely to also have similar risky profiles, at least compared to the population average, and even when taking into account easily attainable factors such age and sex.

The method aims to seek out those individuals who have low risk profiles and their friends, since these would provide profitable prospective insurance clients. The method identifies them and allows for a service provider such as an insurance company to provide them with targeted insurance offers. These offers would be better structured than the typical average offer such a person would receive which would only take into account his or her age, sex and personal accident history. The friends of the person profiled are thus also rewarded for the low risk behaviour of their friend.

In its implementation the method operates by generating market intelligence by providing an incentive to a social media service subscriber to allow access to his social media account data and geographical location data of a mobile communication device associated with the subscriber. It then creates a profile of the subscriber by analysing data submitted to the social media service and geographical location data related to the subscriber, and it provides the profile to a third party offering products or services complimentary to the profile of the subscriber.

The data that is accessed includes data relating to the interests and characteristics of the subscriber. This may include data that the subscriber submitted himself to his social media account such as his likes and dislikes and his posts, including text and media, by the subscriber or about the subscriber by people associated with him.

This data is used to create a profile of the subscriber, indicating specifically whether there are any risk factors associated with the subscriber that may be attributed to any of his interests or characteristics.

This profile of the subscriber provides valuable and relevant insight into especially the insurance risk the subscriber may present.

In addition to this, profiles are also created for people associated with the subscriber's social media account or accounts, and each such profile includes a categorisation of such a person as being at least one of a friend, family member or follower of the subscriber.

The social media account of each of these associated people is then accessed, through the social media account of the subscriber and with his permission, to determine which of them have interests or characteristics similar to that of the subscriber. For those with similar interests or characteristics it is also determined whether the profile of the subscriber any of includes a risk factor attributed to such interests or characteristics and if it does then attributing such risk factor, at least partly, also to the associated person's profile. This is on the assumption as mentioned above that like-minded people flock together, and further that one cannot choose family but you can choose friends and who you follow. For this reason more weight is placed on the risky factors when attributed to a friend or follower than to a family member.

It will also be appreciated that the generation of the profiles for people associated with each other become more accurate when more of them subscribe to the method. When a person associated with a subscriber also subscribes to the method, more information about that person becomes available to the method since not all data about a person is always available to his friends. The profile for that second subscriber, which was originally compiled from the profile of the first subscriber, then becomes more accurate. This more accurate profile is then used in turn to update the profile of the first subscriber, and the profiles of all people that are associated through the social media network with both subscribers (e.g. mutual friends in the Facebook context). In this way the profiles created by the method become more accurate and relevant over time.

It should be borne in mind that risk factors may be positive or negative. Someone may have a high or low risk factor in terms of driving, and a low risk factor may equally be incorporated into the profile of an associated person who shares similar interests or characteristics as the subscriber.

The accessing of the subscriber's social media profile occurs typically at least intermittently, and preferably continuously. The accessing of the subscriber's geographical location data also occurs at least intermittently, and preferably also continuously, and especially so when the subscriber is travelling in a vehicle.

To determine whether a subscriber is travelling in a vehicle his speed of movement is monitored along with the location of his mobile communication device. It is assumed that the typical subscriber will always have his mobile communication device—usually in the form of a GPS enabled smartphone—with him, so data relating to location and movement of the mobile communication device represents that of the subscriber. The travelling path of the subscriber's mobile communication device is checked to determine when it corresponds with a road on a maps database and if the speed of movement exceeds a predetermined minimum speed (that would typically not be possible by foot) then it is assumed that the subscriber is travelling in a vehicle.

In this way it is known where the subscriber is and in which general direction he is travelling. To incentivise the subscriber to become and stay a member of the service—and provide data to the system—he is presented with specifically selected special offers. For this the system accesses a database of service providers and merchants with details of special offers provided by them. These may be service providers and merchants that subscribe for such a service through the system that implements the method to reach a targeted audience provided by the system, or it may be provided by a third party managing such a database.

The interests and characteristics of the subscriber are then compared with special offers in the database to determine which special offers are complimentary to the interests and characteristics of the subscriber. The incentive to the subscriber then takes the form of a selection, from time to time, of at least one special offer from those special offers that are complimentary to the interests and characteristics of the subscriber.

The special offer is transmitted to the subscriber's mobile communication device as a message detailing the special offer, where it is available and a unique redemption code associated with it.

The special offer may also incorporate a geographical element, which it being selected to coincide with a merchant or service provider within the subscriber's general or current geographical location as indicated by his mobile communication device.

The special offer may be time limited with an expiry date or time, alternatively geographically limited and being predetermined to expire once the subscriber travels to a geographical location further than a predetermined distance from the location of the merchant or service provider providing the special offer.

These special offers may take any form, and could for example (without limitation) include special offers at restaurants, fuel stations, convenient stores, clothing stores, music stores, hair salons and the like. For example, a subscriber may drive through a certain area, and receive a special offer for a fast food meal at a fast food restaurant ahead of him (determined from his location and direction of travel).

This provides the subscriber with a real benefit in exchange for allowing the system that operates the method access to his data. The fact that the provision of the incentives are not fixed in time or nature provides an element of excitement to the process. This serves to keep subscribers interested in the system, and willing to continue sharing their data.

The subscriber will also receive offers for services and products from companies using his profile data, which will provide him with a further benefit.

As mentioned above of particular interest is data relevant to insurance providers, especially motor vehicle insurance where individual behaviour forms an integral part of the risk profile of an insured person. The invention may also be applied to other types of insurance, such as health or life insurance, where insurers may be on the lookout for specific types of risky behaviour, either to avoid making offers to such people or to modify an insurance premium for them.

The invention may also be used to target people with specific insurance policies that may otherwise be hard to get, such as insurance policies relating to specific interests including sports and hobbies.

The method thus generates profiles on people that provide relevant market intelligence on them, allowing marketing companies to provide more accurate and relevant offers to them. It also provides a service in two formats, namely:
first by profiling the subscriber and people associated with him and allowing their profile data to be used by a purchaser of data relating to him such as an insurance company, and
secondly by using the same profile data to provide incentives to the subscriber for special offers that are aligned with his interests or characteristics, which provides a targeted market for companies providing such special offers.

The invention thus provides companies that wish to market products or services with new marketing options and with relevant market intelligence that allows them to follow a highly targeted marketing strategy. Their return on their marketing efforts will be greater and people receiving offers from the system should be more receptive since the system will not overload them with irrelevant promotions, but will instead provide them offers on products or services they already have an interest in.

It will be appreciated that the embodiments described above are given by way of example only and are not intended to limit the scope of the invention. It is possible to modify aspects thereof without departing from the essence of the invention.

1. A method of generating market intelligence including the steps of providing an incentive to a social media service subscriber to allow access to his social media account data and geographical location data of a mobile communication device associated with the subscriber, accessing and analysing the subscriber's social media account data and geographical location data related to the subscriber to create a profile of the subscriber, and providing the profile to a third party offering products or services complimentary to the profile of the subscriber.

2. A method as claimed in claim 1 in which the social media account data includes data relating to the interests and characteristics of the subscriber.

3. A method as claimed in claim 1 which includes creating profiles of people associated with the subscriber's social media account, and including in each such profile a categorisation of such a person as being at least one of a friend, family member or follower of the subscriber, and incorporating data relating to subscriber's profile into at least some of the profiles of such associated people.

4. A method as claimed in claim 3 which includes accessing social media account data of the associated people through the social media account of the subscriber, comparing the social media account data of the subscriber and the associated people to determine whether any of the associated people have interests or characteristics similar to that of the subscriber, determining whether the subscriber's profile includes a risk factor attributed to such interests or characteristics and if it does then attributing such risk factor, at least partly, also to the associated person's profile.

5. A method as claimed in claim 1 which includes the step of accessing the subscriber's social media profile at least intermittently, and preferably continuously, and accessing the subscriber's geographical location data at least intermittently, and preferably continuously when the subscriber is travelling in a vehicle, and determining that a subscriber is travelling in a vehicle by monitoring speed of movement and the location of the subscriber's mobile communication device, and when the travelling path of the subscriber's mobile communication device corresponds with road on a maps database and the speed of movement exceeds a predetermined minimum speed to determine that the subscriber is travelling in a vehicle.

6. A method as claimed in claim 1 which includes the step of cross referencing data relating to the subscriber with a database relating to products or services of which the subscriber is a consumer, preferably being products or services offered by a third party, and incorporating data relating to the subscriber from such database into the subscriber's profile.

7. A method as claimed in claim 6 in which the products or services comprise insurance products and services and data from such database that is incorporated into the subscriber's profile includes the claims history of the subscriber in respect of such insurance products and services.

8. A method as claimed in claim 7 in which the insurance products and services comprise motor vehicle insurance, the claims history data includes data relating to accidents in which the subscriber was involved, and the geographical location data includes data relating to the subscriber's driving behaviour, including data relating to:
the subscriber's adherence to speed limits in absolute terms;
the subscriber's acceleration and braking behaviour;
the subscriber's behaviour at negotiating corners;
the average distance the subscriber travels over a predetermined period of time;
the average distance the subscriber travels during low light conditions; and
the subscriber's adherence to corrected speed limits by reducing the absolute speed limit according to prevailing conditions including traffic, incidents or accidents on the road, and any special current weather such as rain, snow or hail.

9. A method as claimed in claim 8 in which the data from the database that is incorporated into the subscriber's profile includes data about the type of vehicle that is insured for the subscriber in terms of the motor vehicle insurance.

10. A method as claimed in claim 9 in which the social media account data includes data indicating a preference of the subscriber for specific types of vehicles, including specifically vehicles within a predetermined group of vehicles classified by the provider of the insurance products and services as high risk vehicles.

11. A method as claimed in claim 1 in which the step of providing an incentive to the subscriber includes accessing a database of service providers and merchants with details of special offers provided by them, comparing the interests and characteristics of the subscriber with the special offers in the database to determine special offers that are complimentary to the interests and characteristics of the subscriber, selecting from time to time at least one special offer from those complimentary to the interests and characteristics of the subscriber and transmitting to the subscriber's mobile communication device a message detailing the special offer and a unique redemption code associated with the special offer.

12. A method as claimed in claim 11 in which the special offer is selected to coincide with a merchant or service provider within the subscriber's general geographical location as indicated by his mobile communication device.

13. A method as claimed in claim 12 in which the special offer is selected to coincide with a merchant or service provider within the subscriber's current geographical location as indicated by his mobile communication device.

14. A method as claimed in claim 11 in which the special offer is time limited with an expiry date or time, alternatively geographically limited and being predetermined to expire once the subscriber travels to a geographical location further than a predetermined distance from the location of the merchant or service provider providing the special offer.
